(19) United States
(12) Patent Application Publication
(10) Pub. No.: US 2003/0114601 A1
(43) Pub. Date: Jun. 19, 2003

(54) Blends of polysulfide silanes with tetraethoxysilane as coupling agents for mineral-filled elastomer compositions

(76) Inventors: Richard W. Cruse, Yorktown Heights, NY (US); Frederick D. Osterholtz, Pleasantville, NY (US)

Correspondence Address: Michael P. Dilworth, CROMPTON CORPORATION, Benson Road, Middlebury, CT, 06749, US

(21) Appl. No.: 09/956,650

(22) Filed: Sep. 19, 2001

(51) Int. Cl. C08C 19/00

(52) U.S. Cl. 525/332.6; 524/588

(57) ABSTRACT

A composition is disclosed that comprises a blend of:

A) at least one hydrolyzable polysulfide silane; and

B) at least one coupling agent selected from the group consisting of hydrolyzable tetraalkoxysilanes, hydrolyzable oligomers of tetraalkoxysilanes, and mixtures thereof.

An article of manufacture comprising an elastomer, a mineral filler, and the above composition is also disclosed.

### BACKGROUND OF THE INVENTION

1. Field of the Invention

The present invention relates to the preparation and processing of mineral-filled elastomers. More particularly, the present invention relates to blends of polysulfide silanes with tetraalkoxysilane and/or its oligomers as coupling agents for mineral-filled elastomer compositions.

2. Description of Related Art

In the preparation of mineral-filled elastomer compositions, it is known to use as the coupling agent a polysulfide silane in which two alkoxysilyl groups are bound, each to one end of a chain of sulfur atoms. These coupling agents function by chemically bonding silica or other mineral fillers to the polymer when used in rubber applications in a relatively simple and straightforward manner. Coupling is accomplished by chemical bond formation between the silane sulfur and the polymer and by hydrolysis of the silane alkoxy groups, followed by condensation with silica hydroxyl groups.

It is known in the art to use auxiliary silanes in conjunction with polysulfide silane coupling agents in mineral-filled rubber compositions. Much of this art deals with the use of tetraethoxysilane (TEOS) as an in siti silica source.

It is also known in the art to use individual silane types that can be employed in the practice of the present invention in conjunction with polymers containing bonds to metals, most notably tin.

### SUMMARY OF THE INVENTION

The present invention relates to the chemical compositions of coupling agents which are blends of distinct types of hydrolyzable silanes, and to the use of these coupling agents in the preparation of elastomer compositions containing mineral fillers. The components of the blended coupling agents include a hydrolyzable polysulfide silane, which joins the filler to the polymer through chemical bonds and a hydrolyzable tetraalkoxysilane and/or its oligomers, preferably TEOS, which can function as a filler surface modifier and extender. These coupling agents are an improvement over those known in the art in that the tetraalkoxysilane and/or its oligomers permit the use of less polysulfide silane, which imparts the potential for better processability of the filled clastomer compositions.

The present invention offers improvements in the preparation of elastomer compositions containing mineral fillers and silane coupling agents. The basis of the present invention is the hydrolysis and subsequent condensation of at least one hydrolyzable tetraalkoxysilane and/or its oligomers, preferably TEOS, in conjunction with at least one hydrolyzable polysulfide silane on the surface of filler particles added to the elastomer composition in the form of silica.

It is an object of the present invention to form a siloxane network on the surface of the added filler, involving all of the silane functionalities introduced into the composition, such that the final result is a synergy between all of the characteristics imparted by two silane types, which cannot be accomplished by one alone. Partial formation of the siloxane network can be accomplished by using partially hydrolyzed and oligomerized silicates, such as ES-40.

The use of simple hydrolyzable alkyl silanes to supplement the use of polysulfide silanes is known in art assigned to The Goodyear Tire and Rubber Company, as a way of hydrophobating the filler surface to improve processing. This art, however, does not include a means of providing a silane hydrolyzable functionality of greater than three. TEOS and its oligomers provide a potential silane hydrolyzable functionality of four (all four ethoxy groups are hydrolyzed). The additional sites of silane hydrolyzability in TEOS and its oligomers lead to a greater potential for siloxane formation and crosslinking at the filler surface in rubber compositions employing these silanes to supplement the polysulfide silanes, which can strengthen the filler-polymer interface. The oligomers of TEOS are less volatile and generate less alcohol upon hydrolysis.

More particularly, the present invention is directed to a composition comprising a blend of:

A) at least one hydrolyzable polysulfide silane; and

B) at least one coupling agent selected from the group consisting of hydrolyzable tetraalkoxysilanes, hydrolyzable oligomers of tetraalkoxysilanes, and mixtures thereof.

In another aspect, the present invention is directed to an article of manufacture comprising:

A) at least one elastomer;

B) at least one mineral filler; and

C) a composition comprising a blend of:

1) at least one hydrolyzable polysulfide silane; and

2) at least one coupling agent selected from the group consisting of hydrolyzable tetraalkoxysilanes, hydrolyzable oligomers of tetraalkoxysilanes, and mixtures thereof.

### DESCRIPTION OF THE PREFERRED EMBODIMENTS

### Hydrolyzable Polysulfide Silanes

The hydrolyzable polysulfide silanes useful in the practice of the present invention include any individual component or mixture of components whose individual structures can be represented by the following general formula:

X¹X²X³Si-G-Sₓ-G-SiX¹X²X³ Formula 1:

In Formula 1:

x is an integer from 2 to 20;

X¹ is selected from the group consisting of —Cl, —Br, —OH, —OR¹, R¹C(═O)O—, and —O—N═CR¹₂ hydrolyzable moieties,

wherein:

R¹ is any hydrocarbon fragment obtained by removal of one hydrogen atom from a hydrocarbon having from 1 to 20 carbon atoms including aryl groups and branched or straight chain alkyl, alkenyl, arenyl, or aralkyl groups;

X² and X³ are independently selected from the group consisting of hydrogen, the members listed above for R¹, and the members listed above for X¹; and

G is a hydrocarbon fragment, obtained by removal of one hydrogen atom of any of the groups listed above for R¹.

Representative examples of X¹ include methoxy, ethoxy, propoxy, isopropoxy, butoxy, phenoxy, benzyloxy, hydroxy, chloro, and acetoxy. Methoxy, ethoxy, and isopropoxy are preferred. Ethoxy is most preferred.

Representative examples of X² and X³ include the representative examples listed above for X¹ as well as hydrogen, methyl, ethyl, propyl, isopropyl, sec-butyl, phenyl, vinyl, cyclohexyl, and higher straight chain alkyls, such as butyl, hexyl, octyl, lauryl, and octadecyl. Methoxy, ethoxy, isopropoxy, methyl, ethyl, phenyl, and the higher straight-chain alkyls are preferred for X² and X³. Ethoxy, methyl, and phenyl are most preferred. It is more preferred X¹, X², and X³ be the same alkoxy group, preferably methoxy, ethoxy, or isopropoxy. Ethoxy is most preferred.

Representative examples of G include the terminal straight-chain alkyls further substituted terminally at the other end, such as —CH₂—, —CH₂CH₂—, —CH₂CH₂CH₂—, and —CH₂CH₂CH₂CH₂CH₂CH₂CH₂CH₂—, and their beta-substituted analogs, such as —CH₂(CH₂)ₘCH(CH₃)—, where m is zero to 17; —CH₂CH₂C(CH₃)₂CH₂—; the structure derivable from methallyl chloride, —CH₂CH(CH₃)CH₂—; any of the structures derivable from divinylbenzene, such as —CH₂CH₂(C₆H₄)CH₂CH₂— and —CH₂CH₂(C₆H₄)CH(CH₃)—, where the notation C₆H₄ denotes a di-substituted benzene ring; any of the structures derivable from butadiene, such as —CH₂CH₂CH₂CH₂—, —CH₂CH₂CH(CH₃)—, and —CH₂CH(CH₂CH₃)—; any of the structures derivable from piperylene, such as —CH₂CH₂CH₂CH(CH₃)—, —CH₂CH₂CH(CH₂CH₃)—, and —CH₂CH(CH₂CH₂CH₃)—; any of the structures derivable from isoprene, such as —CH₂CH(CH₃)CH₂CH₂—, —CH₂CH(CH₃)CH(CH₃)—, —CH₂C(CH₃)CH₂CH₃)—, —CH₂CH₂CH(CH₃)CH₂—, —CH₂CH₂C(CH₃)₂—, and CH₂CH[CH(CH₃)₂]—; any of the isomers of —CH₂CH₂-norbornyl-, —CH₂CH₂-cyclohexyl-; any of the diradicals obtainable from norbornane, cyclohexane, cyclopentane, tetrahydrodicyclopentadiene, or cyclododecene by loss of two hydrogen atoms; the structures derivable from limonene, —CH₂CH(4-methyl-1-C₆H₉—)CH₃, where the notation C₆H₉ denotes isomers of the tri-substituted cyclohexane ring lacking substitution in the 2 position; any of the monovinyl-containing structures derivable from trivinylcyclohexane, such as —CH₂CH₂(vinylC₆H₉)CH₂CH₂— and —CH₂CH₂(vinylC₆H₉)CH(CH₃)—, where the notation C₆H₉ denotes any isomer of the tri-substituted cyclohexane ring; any of the monounsaturated structures derivable from myrcene containing a tri-substituted C═C, such as —CH₂CH[CH₂CH₂CH═C(CH₃)₂]CH₂CH₂—, CH₂CH[CH₂CH₂CH═C(CH₃)₂]CH(CH₃)—, —CH₂C[CH₂CH₂CH═C(CH₃)₂](CH₂CH₃)—, —CH₂CH₂CH[CH₂CH₂CH═C(CH₃)₂]CH₂—, —CH₂CH₂(C—)(CH₃)[CH₂CH₂CH═C(CH₃)₂], and —CH₂CH[CH(CH₃)[CH₂CH₂CH═C(CH₃)₂]]; and any of the monounsaturated structures derivable from myrcene lacking a trisubstituted C═C, such as —CH₂CH(CH═CH₂)CH₂CH₂CH₂C(CH₃)₂—, —CH₂CH(CH═CH₂)CH₂CH₂CH[CH(CH₃)₂]—, —CH₂C(═CH—CH₃)CH₂CH₂CH₂C(CH₃)₂—, —CH₂C(═CH—CH₃)CH₂CH₂CH[CH(CH₃)₂]—, —CH₂CH₂C(═CH₂)CH₂CH₂CH₂C(CH₃)₂—, —CH₂CH₂C(═CH₂)CH₂CH₂CH[CH(CH₃)₂]—, —CH₂CH═C(CH₃)₂CH₂CH₂CH₂C(CH₃)₂—, and —CH₂CH═C(CH₃)₂CH₂CH₂CH[CH(CH₃)₂].

The preferred structures for G are —CH₂—, —CH₂CH₂—, —CH₂CH₂CH₂—, —CH₂CH(CH₃)CH₂—, and any of the diradicals obtained by 2,4 or 2,5 di-substitution of the norbornane-derived structures listed above. —CH₂CH₂CH₂— is most preferred.

### Hydrolyzable Polyalkoxysilanes

The hydrolyzable polyalkoxysilanes useful in the practice of the present invention include any individual component or mixture of components whose individual structures can be represented by Formula 2, Φ¹Φ²Φ³Φ⁴Si, where Φ¹, Φ², Φ³, and Φ⁴ are independently selected alkoxy moieties, each attached to the Si and/or oligomers of the structures represented in Formula 2 resulting from the hydrolysis and condensation of these structures.

Φ¹, Φ², Φ³, and Φ⁴ are preferably independently selected from the group consisting of —OΔ¹ hydrolyzable moieties, wherein Δ¹ is any hydrocarbon fragment obtained by removal of one hydrogen atom from a hydrocarbon having from 1 to 20 carbon atoms including aryl groups and branched or straight chain alkyl, alkenyl, arenyl, or aralkyl groups. Representative examples of Φ¹, Φ², Φ³, and Φ⁴ include methoxy, ethoxy, propoxy, isopropoxy, butoxy, phenoxy, benzyloxy, and acetoxy. Methoxy, ethoxy, and isopropoxy are preferred. Ethoxy is more preferred. It is most preferred that Φ¹, Φ², Φ³, and Φ⁴ all be the same. TEOS is especially preferred.

As used herein, the terms “alkyl” includes straight, branched, and cyclic alkyl groups; “alkenyl” includes any straight, branched, or cyclic alkenyl group containing one or more carbon-carbon double bonds, where the point of substitution can be either at a carbon-carbon double bond or elsewhere in the group; “alkynyl” includes any straight, branched, or cyclic alkynyl group containing one or more carbon-carbon triple bonds and, optionally, one or more carbon-carbon double bonds as well, where the point of substitution can be either at a carbon-carbon triple bond, a carbon-carbon double bond, or elsewhere in the group; “aryl” includes any aromatic hydrocarbon from which one hydrogen atom has been removed; “aralkyl” includes any of the aforementioned alkyl groups, as defined above, in which one or more hydrogen atoms have been substituted by the same number of like and/or different aryl substituents, as defined above; and “arenyl” includes any aryl groups, as defined above, in which one or more hydrogen atoms have been substituted by the same number of like and/or different alkyl substituents, as defined above.

Specific examples of alkyls include methyl, ethyl, propyl, isobutyl, and the like.

Specific examples of alkenyls include vinyl, propenyl, allyl, methallyl, ethylidenyl norbornane, ethylidene norbornyl, ethylidenyl norbornene, ethylidene norbornenyl and the like.

Specific examples of alkynyls include acetylenyl, propargyl, methylacetylenyl and the like.

Specific examples of aryls include phenyl, naphthalenyl, and the like.

Specific examples of aralkyls include benzyl, phenethyl, and the like.

Specific examples of arenyls include tolyl, xylyl and the like.

As used herein, the terms “cyclic alkyl,” “cyclic alkenyl,” and “cyclic alkynyl” also include bicyclic, tricyclic, and higher cyclic structures, as well as the aforementioned cyclic structures further substituted with alkyl, alkenyl, and/or alkynyl groups. Representative examples include norbornyl, norbornenyl, ethylnorbornyl, ethylnorbornenyl, ethylcyclohexyl, ethylcyclohexenyl, cyclohexylcyclohexyl, cyclododecatrienyl, and the like.

The oligomers are formed by the hydrolysis and subsequent condensation of Φ¹Φ²Φ³Φ⁴Si. The oligomers can be linear, branched, or cyclic structures containing from 2 to 20 silicon atoms. The silicon atoms are bound together by means of oxygen atoms, —O—, thereby forming siloxane bonds, Si—O—Si. The oligomer must contain a sufficient number of —OΔ¹ hydrolyzable moieties to prevent the formation of a gel or solid material. The oligomer must contain at least 4 —OΔ¹ hydrolyzable moieties, preferably at least 6 —OΔ¹ hydrolyzable moieties.

In the practice of the present invention, the hydrolyzable polysulfide silane(s) preferably comprise from about 60 to about 99% by weight of the coupling agent blend and, correspondingly, the hydrolyzable polyalkoxysilane(s) comprise from about 40 to about 1% weight of the blend. More preferably, the blends complise from about 90 to about 70% by weight hydrolyzable polysulfide silane(s) and, correspondingly, from about 10 to about 30% by weight hydrolyzable polyalkoxysilane(s).

The elastomers useful with the coupling agents described herein include sulfur vulcanizable rubbers including conjugated diene homopolymers and copolymers, and copolymers of at least one conjugated diene and at least one aromatic vinyl compound. Suitable organic polymers for the preparation of rubber compositions are well known in the art and are described in various textbooks, including The Vanderbilt Rubber Handbook, by R. F. Ohm (R. T. Vanderbilt Company, Inc., 1990), and the Manual for the Rubber Industry, by T. Kemperman and S. Koch, Jr. (Bayer A G, Leverkusen, 1993).

One example of a suitable polymer for use herein is solution-prepared styrene-butadiene rubber (sSBR). This polymer typically has a bound styrene content in the range of from 5 to 50, preferably from 9 to 36 weight percent and a vinyl content from 10 to 60 weight percent, and preferably 20 to 55 weight percent. Other useful polymers include styrene-butadiene rubber (SBR), natural rubber (NR), ethylene-propylene copolymers and terpolymers (EP, EPDM), acrylonitrile-butadiene rubber (NBR), polybutadiene (BR), and the like.

The rubber composition comprises at least one diene-based elastomer, or rubber. Suitable conjugated dienes are isoprene and 1,3-butadiene and suitable vinyl aromatic compounds are styrene and alpha methyl styrene. Polybutadiene can be characterized as existing primarily (typically about 90 percent by weight) in the cis-1,4-butadiene form.

Thus, the rubber is a sulfur curable rubber. Such diene based elastomer, or rubber, may be selected, for example, from at least one of cis-1,4-polyisoprene rubber (natural and/or synthetic), emulsion polymerization prepared styrene/butadiene copolymer rubber, organic solution polymerization prepared styrene/butadiene rubber, 3,4-polyisoprene rubber, isoprene/butadiene rubber, styrene/isoprene/butadiene terpolymer rubber, cis-1,4-polybutadiene, medium vinyl polybutadiene rubber (35-50 percent vinyl), high vinyl polybutadiene rubber (50 to 75 percent vinyl), styrene/isoprene copolymers, emulsion polymerization prepared styrene/butadiene/acrylonitrile terpolymer rubber and butadiene/acrylonitrile copolymer rubber.

For some applications, an emulsion polymerization derived styrene/butadiene (eSBR) having a relatively conventional styrene content of about 20 to 28 percent bound styrene, or an eSBR having a medium to relatively high bound styrene content of about 30 to 45 percent may be used.

Emulsion polymerization prepared styrene/butadiene/acrylonitrile terpolymer rubbers containing 2 to 40 weight percent bound acrylonitrile in the terpolymer are also contemplated as diene based rubbers for use in this invention.

A particulate filler is also added to the crosslinkable elastomer compositions of the present invention, including siliceous fillers, other mineral fillers, carbon black, and the like. The filler materials useful herein include, but are not limited to, metal oxides, such as silica (pyrogenic and precipitated), titanium dioxide, aluminosilicate and alumina, clays and talc, silica modified carbon black, carbon black, and the like.

Particulate, precipitated silica is also sometimes used for such purpose, particularly when the silica is used in conjunction with a silane. In some cases, a combination of silica and carbon black is utilized for reinforcing fillers for various rubber products, including treads for tires. Alumina can be used either alone or in combination with silica. The term, alumina, can be described herein as aluminum oxide, or Al₂O₃. The fillers may be hydrated or in anhydrous form. Use of alumina in rubber compositions is described, for example, in U.S. Pat. No. 5,116,886 and EP 631982.

The blends of the present invention can be premixed or pre-reacted with the filler particles, or can be added to the rubber mix during the rubber and filler processing, or mixing stages.

The vulcanized rubber composition should contain a sufficient amount of filler to contribute a reasonably high modulus and high resistance to tear. The combined weight of the filler may be as low as about 5 to about 100 phr but is more preferably from about 25 to about 85 phr.

Preferably, at least one precipitated silica is utilized as a filler. The silica may be characterized by having a BET surface area, as measured using nitrogen gas, preferably in the range of about 40 to about 600 m²/g, more preferably in the range of from about 50 to about 300 m²/g. The BET method of measuring surface area is known in the art. The silica typically has a dibutylphthalate (DBP) absorption value in a range of 100 to 350 ml/100 grams, more usually, 150 to 300 ml/100 grams. Further, the silica, as well as the alumina and aluminosilicate mentioned above, may be expected to have a CTAB surface area in a range of 100 to 220 m²/g. The CTAB surface area is the external surface area as evaluated by cetyl trimethylammonium bromide with a pH of 9. The method is described in ASTM D 3849.

The average mercury porosity specific surface area for the silica should be in a range of from about 100 to about 300 m²/g. Mercury porosity surface area is the specific surface area determined by mercury porosimetry. Using this method, mercury is penetrated into the pores of the sample after a thermal treatment to remove volatiles. Set up conditions may be suitably described as using a 100 mg sample; removing volatiles over a period of two hours at 105° C. and ambient atmospheric pressure; ambient to 2000 bars pressure measuring range. Such an evaluation may be performed according to the method described in Winslow, Shapiro in ASTM bulletin, page 39 (1959) or according to DIN 66133. For such an evaluation, a CARLO-ERBA Porosimeter 2000 might be used.

A suitable pore size distribution for the silica, alumina and aluminosilicate according to such mercury porosity evaluation is considered herein to be such that five percent or less of its pores have a diameter of less than about 10 nm, 60 to 90 percent of its pores have a diameter of 10 to 100 nm, 10 to 30 percent of its pores have a diameter at 100 to 1,000 nm, and 5 to 20 percent of its pores have a diameter of greater than about 1,000 nm.

The silica typically has an average ultimate particle size in the range of, for example, 10 to 50 nm as determined by the electron microscope, although the silica particles may be even smaller or, possibly, larger in size. Various commercially available silicas may be considered for use in this invention, such as HI-SIL 210, 243, etc. (PPG Industries); ZEOSIL 1165 MP (Rhodia); ULTRASIL VN2, VN3, and 7000GR, etc. (Degussa); and ZEOPOL 8745 and 8715 (Huber).

In compositions for which it is desirable to utilize siliceous fillers, such as silica, alumina, and/or aluminosilicates in combination with carbon black reinforcing pigments, the compositions may comprise a filler mix of from about 15 to about 95 weight percent of the siliceous filler, and from about 5 to about 85 weight percent carbon black, wherein the carbon black has a CTAB value in a range of 80 to 150 m²/g. More typically, it is desirable to use a weight ratio of siliceous fillers to carbon black of at least about 1/1, and preferably at least about 3/1. The siliceous filler and carbon black may be preblended or added separately during mixing of the vulcanizable rubber.

In practice, sulfur vulcanized rubber products are typically prepared by thermomechanically mixing rubber and various ingredients in a sequential, stepwise, manner, followed by shaping and heating the compounded rubber to form a vulcanized (cured) product. Thermomechanical mixing refers to the phenomenon whereby, owing to the shear forces and associated friction occurring as a result of mixing the rubber compound, or some blend of the rubber compound itself and rubber compounding ingredients, in a high shear mixer, the temperature autogeneously increases, i.e., it “heats up.”

First, for the mixing of the rubber and various ingredients, usually exclusive of sulfur and sulfur vulcanization accelerators (collectively, curing agents), the rubber(s) and various rubber compounding ingredients typically are blended in at least one, and often (in the case of silica filled low rolling resistance tires) two or more, preparatory thermomechanical mixing stage(s) in suitable mixers. Such preparatory mixing is referred to as nonproductive mixing or nonproductive mixing steps or stages. Such preparatory mixing usually is conducted at temperatures of about 140° C. to 200° C., usually about 150° C. to 180° C., in the mixer.

Subsequent to such preparatory mix stages, in a final mixing stage, sometimes referred to as a productive mix stage, curing agents, and possibly one or more additional ingredients, are mixed with the rubber compound or composition, at lower temperatures of typically about 50° C. to about 110° C. in order to prevent or retard premature curing of the sulfur curable rubber, sometimes referred to as scorching. The rubber mixture, also referred to as a rubber compound or composition, typically is allowed to cool, for example, to a temperature of about 50° C. or lower, sometimes after or during a process intermediate mill mixing, between the various mixing steps. When it is desired to mold and to cure the rubber, it is formed into an appropriate shape and brought to a temperature of at least about 130° C., and up to about 200° C., which will cause the vulcanization of the rubber by the sulfur sources in the rubber mixture.

Sulfur sources that may be used include, for example, elemental sulfur, such as, but not limited to, S₈. A sulfur donor is considered herein as a sulfur-containing compound that liberates free, or elemental, sulfur at a temperature in a range of from about 140° C. to about 190° C. Such sulfur donors include, but are not limited to, polysulfide vulcanization accelerators and organosilane polysulfides with at least three connecting sulfur atoms in the polysulfide bridge. The amount of free sulfur source addition to the mixture can be controlled or manipulated as a matter of choice relatively independent of the addition of the blend of polysulfide silane with tetraalkoxy silane and/or its oligomer. Thus, for example, the independent addition of a sulfur source may be manipulated by the amount of addition thereof and by the sequence of addition relative to the addition of other ingredients to the rubber mixture.

A desirable rubber composition may therefore comprise:

(1) about 100 parts by weight of at least one sulfur vulcanizable rubber selected from the group consisting of conjugated diene homopolymers and copolymers and copolymers of at least one conjugated diene and at least one aromatic vinyl compound,

(2) about 5 to 100 parts, preferably about 25 to 80 parts, per 100 parts by weight rubber of at least one particulate filler,

(3) up to about 5 parts by weight per 100 parts by weight rubber of a curing agent, and

(4) from greater than 0 up to about 15 parts by weight, preferably from about 0.1 up to about 10 parts by weight, per 100 parts by weight rubber, of the blend of polysulfide silane with tetraalkoxy silane and/or its oligomers.

The filler preferably is from 15 to 100 weight percent siliceous filler, such as silica and from about 0 to about 85 weight percent carbon black based on the total weight of the filler.

Where a curing agent is employed, it is added in a thermomechanical productive mixing step at a temperature of from about 25° C. to about 110° C., more preferably from about 50° C. to about 110° C., and mixed for about 1 to 30 minutes. After shaping, the temperature is raised again to between about 130° C. and about 200° C. and curing is accomplished in about 5 to about 60 minutes.

The process may also comprise the additional steps of preparing an assembly of a tire or sulfur vulcanizable rubber with a tread comprised of the rubber composition prepared according to the present invention and vulcanizing the assembly at a temperature in a range of from about 130° C. to about 200° C.

Optional ingredients that may be added to the rubber compositions of the present invention include curing aids, i.e. sulfur compounds, including activators, retarders and accelerators, processing additives, such as oils, plasticizers, tackifying resins, silicas, other fillers, pigments, fatty acids, zinc oxide, waxes, antioxidants and antiozonants, peptizing agents, reinforcing materials such as, for example, carbon black, and the like. Any such additives are selected based upon the intended use and on the sulfur vulcanizable material selected for use, which selections are within the knowledge of those skilled in the art, as are the required amounts of such additives.

The vulcanization may be conducted in the presence of additional sulfur vulcanizing agents. Examples of suitable sulfur vulcanizing agents include, for example, elemental sulfur (free sulfur) or sulfur donating vulcanizing agents, for example, an amino disulfide, polymeric polysulfide or sulfur olefin adducts that are conventionally added in the final, productive, rubber composition mixing step. The sulfur vulcanizing agents (which are common in the art) are used, or added in the productive mixing stage, in an amount ranging from about 0.4 to about 3 phr, or even, in some circumstances, up to about 8 phr, with a range of from about 1.5 to about 2.5 phr being preferred.

Optionally, vulcanization accelerators may be used herein. It is appreciated that they may be, for example, of the type such as, for example, benzothiazole, alkyl thiuram disulfide, guanidine derivatives, and thiocarbamates. Examples of such accelerators include, but not limited to, mercapto benzothiazole, tetramethyl thiuram disulfide, benzothiazole disulfide, diphenylguanidine, zinc dithiocarbamate, alkylphenoldisulfide, zinc butyl xanthate, N-dicyclohexyl-2-benzothiazolesulfenamide, N-cyclohexyl-2-benzothiazolesulfenamide, N-oxydiethylenebenzothiazole-2-sulfenamide, N,N-diphenylthiourea, dithiocarbamylsulfenamide, N,N-diisopropylbenzothiozole-2-sulfenamide, zinc-2-mercaptotoluimidazole, dithiobis(N-methyl piperazine), dithiobis(N-beta-hydroxy ethyl piperazine) and dithiobis(dibenzyl amine).

Additionally, sulfur donors may be used, for example, thiuram and morpholine derivatives. Examples of such donors include, but are not limited to, dimorpholine disulfide, dimorpholine tetrasulfide, tetramethyl thiuram tetrasulfide, benzothiazyl-2,N-dithiomorpholide, thioplasts, dipentamethylenethiuram hexasulfide, and disulfidecaprolactam.

Accelerators are used to control the time and/or temperature required for vulcanization and to improve the properties of the vulcanizate. In one embodiment, a single accelerator system may be used, i.e., a primary accelerator. Conventionally and preferably, at least one primary accelerator is used in a total amount ranging from about 0.5 to about 4, preferably about 0.8 to about 1.5 phr. Combinations of a primary and a secondary accelerator may be used, with the secondary accelerator being used in smaller amounts (about 0.05 to about 3 phr) in order to activate and improve the properties of the vulcanizate. Suitable types of accelerators include amines, disulfides, guanidines, thioureas, thiazoles, thiurams, sulfenamides, dithiocarbamates and xanthates. Preferably, the primary accelerator is a sulfenamide. If a second accelerator is used, the secondary accelerator is preferably a guanidine, dithiocarbamate, or thiuram compound. Delayed action accelerators may be used. Vulcanization retarders might also be used.

Tackifier resins, if used, are typically employed at a level of from about 0.5 to about 10 phr, usually about 1 to about 5 phr. Typical amounts of processing aids are from about 1 to about 50 phr. Such processing aids can include, for example, aromatic, naphthenic, and/or paraffinic processing oils. Typical amounts of antioxidants are from about 1 to about 5 phr. Representative antioxidants include diphenyl-p-phenylenediamine and others, such as, for example, those disclosed in the Vanderbilt Rubber Handbook (1978), pages 344 to 346. Typical amounts of antiozonants are from about 1 to about 5 phr. Typical amounts of fatty acids (which can include stearic acid), if used, are from about 0.5 to about 3 phr. Typical amounts of zinc oxide are about 2 to about 5 phr. Typical amounts of waxes are from about 1 to about 5 phr. Often microcrystalline waxes are used. Typical amounts of peptizers are from about 0.1 to about 1 phr. Typical peptizers may be, for example, pentachlorothiophenol and dibenzamidodiphenyl disulfide.

The rubber composition of this invention can be used for various purposes. For example, it can be used for various tire compounds. Such tires can be built, shaped, molded and cured by various methods which are known and will be readily apparent to those having skill in such art. The rubber compositions can also be used for mechanical goods, such as belts, hoses, and the like, and shoe soles.

Various features and aspects of the present invention are illustrated further in the examples that follow. While these examples are presented to show one skilled in the art how to operate within the scope of the invention, they are not intended in any way to serve as a limitation upon the scope of the invention.

### EXAMPLES

There are at least two basic mix procedures commonly reported for compounding silica filled rubber used in tires. The current technology uses what is referred to a “2 pass mix” for the “nonproductive” mix stage in a large internal mixer, such as F80 liter, F370 liter, and F620 liter Banbury® internal mixers:

Typically, First Pass in a Banbury F80 mixer:

1. Add sSBR and BR, ram down mix (RDM) 30 seconds at 41 RPM.

2. Add one half of the total quantity of silica, all silane, RDM 30 seconds.

3. Add one half of the total quantity of silica, all oil, RDM 30 seconds.

4. Brush (sweep), RDM 20 seconds.

5. Brush, increase RPM to 71, RDM to 160° C.

6. Dump, sheet off 1525 mm roll mill. Cool to room temperature.

Typically, Second Pass:

1. Add compound from first pass. RDM 30 seconds at 41 RPM.

2. Add ZnO, stearic acid, wax, 6PPD, carbon black, RDM 30 seconds.

3. Brush. RPM to 71, RDM to 160° C.

4. Hold at 155° C. to 160° C. for eight minutes by adjusting RPM as needed.

5. Dump. Sheet off 1525 mm roll mill. Cool to room temperature.

This process can be reduced to a “one pass mix” in a Banbury F80 internal mixer as follows:

1. Add sSBR and BR, ram down mix (RDM) 30 seconds at 41 RPM.

2. Add one half of the total quantity of silica, all silane, RDM 30 seconds.

3. Add one half of the total quantity of silica, all oil, RDM 30 seconds.

4. Brush (sweep), RDM 20 seconds.

5. Brush, RDM 20 seconds.

6. Add ZnO, stearic acid, wax, 6PPD, carbon black, RDM 30 seconds.

7. Brush. RPM to 71, RDM to 170° C.

8. Hold at 165° C. to 175° C. for eight minutes by adjusting RPM as needed.

9. Dump. Sheet off 1525 mm roll mill. Cool to room temperature.

Both procedures produce what are referred to as nonproductive compounds. Both then require an additional pass to make a finished (productive) compound. The additional pass is usually done in an internal mixer on a commercial scale, but can be done on a roll mill to avoid cross-contamination problems.

Additional Pass (Productive Mix):

1. Band compound from end of first or second pass roll mill, roll temperatures 50° to 60° C.

2. Add sulfur and accelerators.

3. Mix by cutting six times on each side, folding the sides into the center of the mill. Allow a rolling nip to form between cuts, typically 15 to 30 seconds mixing time between cuts.

4. Sheet off mill and cool to room temperature.

Processibility tests are then performed, and test samples are prepared. Appropriate procedures are as follows:

| | |
|---|---|
| Mooney viscosity and scorch | ASTM D1646 |
| Oscillating disc rheometer | ASTM D2084 |
| Curing of test plaques | ASTM D3182 |
| Stress-strain properties | ASTM D412 |
| Abrasion | DIN 53 516 |
| Heat build-up | ASTM D623 |

The formulation, mix procedures, and examples below all apply to experiments in an F80 (80 liter) Farrell “Banbury” mixer.

Silanes Used

| Designation | Chemical name |
|---|---|
| Silquest ® A-1289 | bis(3-triethoxysilyl-1-propyl) tetrasulfide |
| Silquest ® A-1589 | bis(3-triethoxysilyl-1-propyl) disulfide |

### Reactive Diluents with A-1589

Formulation: 75 Solflex 1216 sSBR, 25 Budene 1207 BR, 80 Zeosil 1165MP silica, 32.5 Sundex 3125 process oil, 2.5 Kadox 720C zinc oxide, 1.0 Industrene R stearic acid, 2.0 Flexzone 7P antiozonant, 1.5 Sunproof Improved wax, 3.0 N330 carbon black, 1.4 Rubbermakers sulfur 104, 1.7 Delac S CBS, 2.0 DPG, Silanes as shown.

2 pass mix, 8 minute thermal @ 155° to 160° C.

| | 1 | 2 |
|---|---|---|
| A-1589 | 6.2 | 4.35 |
| Tetraethylorthosilicate | — | 1.85 |
| Mooney Viscosity @ 100° C. | | |
| ML1+4 | 63 | 63 |
| Mooney Scorch @ 135° C. | | |
| M_{V} | 29 | 29 |
| MS1+, t₃, minutes | 9.5 | 10.3 |
| MS1+, t₁₈, minutes | 13.0 | 13.5 |
| ODR @ 149° C., 1° arc, 30 minute timer | | |
| M_{L}, in.-lb. | 7.6 | 7.5 |
| M_{H}, in.-lb. | 28.5 | 26.6 |
| t_{S1}, minutes | 5.0 | 5.2 |
| t90, minutes | 18.1 | 18.2 |
| Physical Properties, cured t90 @ 149° C. | | |
| Hardness, Shore A | 62 | 58 |
| Elongation, % | 540 | 580 |
| 25% Modulus, psi. | 110 | 105 |
| 100% Modulus, psi. | 240 | 220 |
| 300% Modulus, psi. | 1245 | 510 |
| Tensile, psi. | 3240 | 3160 |
| 300%/25% | 11.3 | 4.9 |
| 300%/100% | 5.2 | 2.3 |

### A-1289/TEOS Blends In Shoe Soles

Formulation: 60 Budene 1207 BR, 20 SMR L NR, 20 Perbunan NT3445 NBR, 42 Hisil 233 silica, 2DEG, 1 Naugard BHIT, 1 Sun-proof Improved wax, 1.5 Rhenofit 3555 activator, 4 Kadox 720C zinc oxide, 1.0 Industrene R stearic acid, 2 Aflux 12 disperser, 2 Rhenosin N260 homogenizer, 2 Rubbermakers sulfur 104, 1 Naugex MBTS, 0.2 Naugex MBT, 0.15 Rhenogran TMTM-80, Silane as shown.

| Run No. | 1 | 2 | 3 | 4 | 5 | 6 | 7 | 8 | 9 |
|---|---|---|---|---|---|---|---|---|---|
| A-1289 | — | 2.0 | 5.0 | 2.0 | 5.0 | 1.6 | 4.0 | 1.4 | 3.5 |
| Tetraethylorthosilicate | — | — | — | — | — | 0.4 | 1.0 | 0.6 | 1.5 |
| Note: Compounds 4 and 5 had a five-minute thermal step @ 150-155° C. at end of Banbury mix. Rest were just brought to 150° C. and dumped. | | | | | | | | | |
| ODR @ 150° C., 1 arc, 30 minute timer | | | | | | | | | |
| t90, minutes | 4.4 | 6.0 | 8.2 | 6.0 | 8.0 | 5.3 | 7.1 | 5.2 | 7.2 |
| Physical Properties, cured t90 @ 150° C. | | | | | | | | | |
| Hardness, Shore A | 59 | 62 | 63 | 59 | 60 | 63 | 63 | 63 | 63 |
| Elongation, % | 750 | 700 | 630 | 600 | 580 | 690 | 610 | 700 | 610 |
| 100% Modulus, psi. | 260 | 335 | 370 | 325 | 345 | 340 | 355 | 345 | 365 |
| 300% Modulus, psi. | 615 | 930 | 1070 | 955 | 1070 | 925 | 1030 | 920 | 1030 |
| Tensile, psi. | 2960 | 2950 | 2850 | 2450 | 2710 | 2940 | 2640 | 3030 | 2640 |
| DIN Abrasion, mm³ | 66 | 60 | 60 | 58 | 54 | 62 | 59 | 64 | 62 |
| Akron Abrasion | 0.470 | 0.463 | 0.443 | 0.440 | 0.482 | 0.480 | 0.401 | 0.458 | 0.409 |

### Blends of A-1289 and TEOS

Formulation: 75 Solflex 1216 sSBR, 25 Budene 1207 BR, 80 Zeosil 1165MP silica, 32.5 Sundex 3125 process oil, 2.5 Kadox 720C zinc oxide, 1.0 Industrene R stearic acid, 2.0 Santoflex 13 antioxidant, 1.5 M4067 microwax, 3.0 N330 carbon black, 1.4 Rubbermakers sulfur 104, 1.7 CBS, 2.0 DPG, Silane as shown

| | 1 | 2 | 3 | 4 |
|---|---|---|---|---|
| A-1289 | 7 | 6.3 | 5.6 | 4.9 |
| Tetraethylorthosilicate | — | 0.7 | 1.4 | 2.1 |
| Mooney Viscosity @ | | | | |
| 100° C. | | | | |
| ML1+4 | 78 | 76 | 76 | 78 |
| Mooney Scorch @ | | | | |
| 135° C. | | | | |
| M_{V} | 35 | 34 | 34 | 34 |
| MS1+, t₃, minutes | 6.2 | 6.2 | 6.4 | 6.1 |
| MS1+, t₁₈, minutes | 9.1 | 9.4 | 9.5 | 9.0 |
| ODR @ 149° C., 1° arc, | | | | |
| 30 minute timer | | | | |
| M_{L}, in.-lb. | 7 | 6.8 | 7.0 | 7.4 |
| M_{H}, in.-lb. | 29.0 | 28.5 | 28.0 | 27.7 |
| t_{S1}, minutes | 3.8 | 4.4 | 4.0 | 4.0 |
| t90, minutes | 19.0 | 18.8 | 18.5 | 18.3 |
| Physical Properties, | | | | |
| cured t90 @ 149° C. | | | | |
| Hardness, Shore A | 62 | 63 | 62 | 62 |
| Elongation, % | 440 | 460 | 450 | 460 |
| 25% Modulus, psi. | 120 | 125 | 130 | 130 |
| 100% Modulus, psi. | 300 | 295 | 305 | 295 |
| 300% Modulus, psi. | 1670 | 1610 | 1595 | 1480 |
| Tensile, psi. | 2980 | 3020 | 2940 | 2810 |
| 300%/25% | 13.9 | 12.9 | 12.3 | 11.4 |
| 300%/100% | 5.6 | 5.5 | 5.2 | 5.0 |
| Dynamic Properties | | | | |
| in the cured state | | | | |
| Nonlinearity (0-10%) | | | | |
| G′ᵢₙᵢₜᵢₐₗ (MPa) | 2.60 | 3.10 | 3.00 | 2.60 |
| ΔG′ (MPa) | 0.90 | 1.34 | 1.30 | 1.03 |
| G″ₘₐₓ (MPa) | 0.320 | 0.392 | 0.393 | 0.345 |
| tan δ, ₘₐₓ | 0.160 | 0.180 | 0.185 | 0.180 |
| Large strain hysteresis | | | | |
| tan δ, 35% DSA | 0.119 | 0.127 | 0.136 | 0.137 |

In view of the many changes and modifications that can be made without departing from principles underlying the invention, reference should be made to the appended claims for an understanding of the scope of the protection to be afforded the invention.

What is claimed is:

1. A composition comprising a blend of:
A) at least one hydrolyzable polysulfide silane; and
B) at least one coupling agent selected from the group consisting of hydrolyzable tetraalkoxysilanes, hydrolyzable oligomers of tetraalkoxysilanes, and mixtures thereof.

2. The composition of claim 1 wherein the hydrolyzable polysulfide silane is represented by the general formula:
X¹X²X³Si-G-Sₓ-G-SiX¹X²X³
wherein
x is an integer from 2 to 20;
X¹ is selected from the group consisting of —Cl, —Br, —OH, —OR¹, R¹C(═O)O—, and —O—N═CR¹₂ hydrolyzable moieties,
R¹ is any hydrocarbon fragment obtained by removal of one hydrogen atom from a hydrocarbon having from 1 to 20 carbon atoms including aryl groups and branched or straight chain alkyl, alkenyl, arenyl, or aralkyl groups;
X² and X³ are independently selected from the group consisting of hydrogen, the members listed above for R¹, and the members listed above for X¹; and
G is a hydrocarbon fragment, obtained by removal of one hydrogen atom of any of the groups listed above for R¹.

3. The composition of claim 2 wherein X¹, X², and X³ are independently selected alkoxy groups.

4. The composition of claim 3 wherein X¹, X², and X³ are ethoxy groups.

5. The composition of claim 1 wherein G is —CH₂CH₂CH₂—.

6. The composition of claim 2 wherein G is —CH₂CH₂CH₂—.

7. The composition of claim 3 wherein G is —CH₂CH₂CH₂—.

8. A composition comprising a blend of:
A) tetraethoxysilane; and
B) at least one coupling agent selected from the group consisting of bis(3-triethoxysilyl-1-propyl) tetrasulfide and bis(3-triethoxysilyl-1-propyl) disulfide.

9. An article of manufacture comprising:
A) at least one elastomer;
B) at least one mineral filler; and
C) a composition comprising a blend of:
1) at least one hydrolyzable polysulfide silane; and
2) at least one coupling agent selected from the group consisting of hydrolyzable tetraalkoxysilanes, hydrolyzable oligomers of tetraalkoxysilanes, and mixtures thereof.

10. The article of claim 9 wherein the hydrolyzable polysulfide silane is represented by the general formula:
X¹X²X³Si-G-Sₓ-G-SiX¹X²X³
wherein
x is an integer from 2 to 20;
X¹ is selected from the group consisting of —Cl, —Br, —OH, —OR¹, R¹C(═O)O—, and —O—N═CR¹₂ hydrolyzable moieties,
R¹ is any hydrocarbon fragment obtained by removal of one hydrogen atom from a hydrocarbon having from 1 to 20 carbon atoms including aryl groups and branched or straight chain alkyl, alkenyl, arenyl, or aralkyl groups;
X² and X³ are independently selected from the group consisting of hydrogen, the members listed above for R¹, and the members listed above for X¹; and
G is a hydrocarbon fragment, obtained by removal of one hydrogen atom of any of the groups listed above for R¹.

11. The article of claim 10 wherein X¹, X², and X³ are independently selected alkoxy groups.

12. The article of claim 11 wherein X¹, X², and X³ are ethoxy groups.

13. The article of claim 9 wherein G is —CH₂CH₂CH₂—.

14. The article of claim 10 wherein G is —CH₂CH₂CH₂—.

15. The article of claim 11 wherein G is —CH₂CH₂CH₂—.

16. An article of manufacture comprising:
A) at least one elastomer;
B) at least one mineral filler; and
C) a composition comprising a blend of:
1) tetraethoxysilane; and
2) at least one coupling agent selected from the group consisting of bis(3-triethoxysilyl-1-propyl) tetrasulfide and bis(3-triethoxysilyl-1-propyl) disulfide.

17. The article of claim 9 wherein said article is a tire.

18. The article of claim 9 wherein said article is a belt.

19. The article of claim 9 wherein said article is a hose.

20. The article of claim 9 wherein said article is a shoe sole.
